(19) United States
(12) Patent Application Publication
(10) Pub. No.: US 2025/0184793 A1
(43) Pub. Date: Jun. 5, 2025

(54) DEVICES, METHODS, APPARATUSES, AND COMPUTER READABLE MEDIA FOR HIERARCHICAL MEASUREMENT MECHANISM

(71) Applicant: Nokia Technologies Oy, Espoo (FI)

(72) Inventors: Jianguo LIU, Minhang Shanghai (CN); Wenyi XU, Shanghai (CN); Fei GAO, Shanghai (CN)

(21) Appl. No.: 18/875,939

(22) PCT Filed: Jun. 20, 2022
(86) PCT No.: PCT/CN2022/099734

§ 371 Date: Dec. 17, 2024

(51) Int. Cl. H04W 24/10; H04L 5/00

(52) U.S. Cl. CPC H04W 24/10; H04L 5/0048

(57) ABSTRACT

A first device in a radio access network includes at least one processor and at least one memory. The at least one memory includes computer program code, and the at least one memory and the computer program code are configured to, with the at least one processor, cause the first device to perform: receiving from a third device, information indicative of one or more reference signal configurations and associated events, wherein the one or more reference signal configurations are associated with transmission of a reference signal from the second device in the radio access network to the first device; and detecting one or more events based at least on the one or more reference signal configurations.

### TECHNICAL FIELD

Various embodiments relate to devices, methods, apparatuses, and computer readable media for hierarchical measurement mechanism.

### BACKGROUND

Radio frequency (RF) sensing may be based on model or based on artificial intelligence (AI)/machine learning (ML). In wireless communication system, joint communication and sensing (JCAS) is to make RF sensing on a basis of communication. In JCAS, several deterministic signals, such as sounding reference signal (SRS) for uplink, channel state information reference signal (CSI-RS) for downlink, demodulation reference signal (DMRS), synchronization signal (SS), physical broadcast channel (PBCH), etc. may be used as sensing reference signal (SEN-RS). In a sensing frame, frequency bandwidth and/or time-domain transmission interval of the SEN-RS will affect sensing resolution, e.g. range resolution, Doppler shift resolution. Furthermore, the number of subcarriers and/or the period of the sensing frame would also have impact on the sensing ambiguity, e.g. range ambiguity, Doppler ambiguity. To improve the sensing performance, the number of available SEN-RS in time domain and/or frequency domain may be increased, but at the cost of complexity and resource overhead. For example, if a sensing receiver (SR) measures the SEN-RS on more occasions, additional measurement complexity and power consumption of SR would be caused. To deal with high-level AI-powered sensing, a SR needs to report the sensing measurement to a remote or network sensing processing entity with powerful computing capability. The sensing measurement report overhead would increase as the number of available SEN-RS increases, which could degrade the network communication efficiency and also increase the power consumption of the SR. Moreover, communication and sensing in the JCAS system may share the same physical resources. Thus, increasing the SEN-RS would probably decrease the available resources, e.g. the time/frequency resources, and/or the spatial resources such as beam resource, for communication, which would affect the communication performance.

### SUMMARY

A brief summary of exemplary embodiments is provided below to provide basic understanding of some aspects of various embodiments. It should be noted that this summary is not intended to identify key features of essential elements or define scopes of the embodiments, and its sole purpose is to introduce some concepts in a simplified form as a preamble for a more detailed description provided below.

In a first aspect, disclosed is a first device in a radio access network. The first device may include at least one processor and at least one memory. The at least one memory may include computer program code, and the at least one memory and the computer program code may be configured to, with the at least one processor, cause the first device to perform: receiving from a third device, information indicative of one or more reference signal configurations and associated events, wherein the one or more reference signal configurations may be associated with transmission of a reference signal from the second device in the radio access network to the first device; and detecting one or more events based at least on the one or more reference signal configurations.

In some example embodiments, the at least one memory and the computer program code may be further configured to, with the at least one processor, cause the first device to further perform: transmitting to the third device, a capability of the first device, wherein the capability may comprise at least one of the following: a computing capability, a machine learning capability, at least one executable sensing task, device category, and power status.

In some example embodiments, the one or more reference signal configurations may comprise a first reference signal configuration, and the at least one memory and the computer program code may be further configured to, with the at least one processor, cause the first device to further perform: performing measurement on the reference signal received from the second device using the first reference signal configuration, wherein the one or more events may be detected based on the measurement.

In some example embodiments, the at least one memory and the computer program code may be further configured to, with the at least one processor, cause the first device to further perform: receiving from the third device, a second reference signal configuration associated with the transmission of the reference signal from the second device to the first device.

In some example embodiments, the one or more reference signal configurations may comprise a second reference signal configuration associated with the transmission of the reference signal from the second device to the first device.

In some example embodiments, the at least one memory and the computer program code may be further configured to, with the at least one processor, cause the first device to further perform: transmitting to the second device or the third device, an indication indicative of the one or more events upon detecting the one or more events; and performing the measurement on the reference signal received from the second device using the second reference signal configuration.

In some example embodiments, the at least one memory and the computer program code may be further configured to, with the at least one processor, cause the first device to further perform: transmitting to the third device, an indication indicative of the one or more events upon detecting the one or more events; receiving from the third device, a second reference signal configuration associated with the transmission of the reference signal from the second device to the first device; and performing the measurement on the reference signal received from the second device using the second reference signal configuration.

In some example embodiments, the at least one memory and the computer program code may be further configured to, with the at least one processor, cause the first device to further perform: reporting to the third device, a result of the measurement performed on the reference signal using the second reference signal configuration.

In some example embodiments, the at least one memory and the computer program code may be further configured to, with the at least one processor, cause the first device to further perform: stopping the measurement on the reference signal using the second reference signal configuration upon detecting one or more events associated with the first reference signal configuration, or receiving from the third device, an indication to stop the measurement on the reference signal using the second reference signal configuration, wherein the one or more events associated with the first reference signal configuration may be detected based on at least one of the first reference signal configuration and the second reference signal configuration.

In some example embodiments, the at least one memory and the computer program code may be further configured to, with the at least one processor, cause the first device to further perform: stopping the measurement on the reference signal using the first reference signal configuration upon detecting the one or more events.

In some example embodiments, the at least one memory and the computer program code may be further configured to, with the at least one processor, cause the first device to further perform: resuming the measurement on the reference signal using the first reference signal configuration upon detecting one or more events associated with the first reference signal configuration, or receiving from the third device, the indication to stop the measurement on the reference signal using the second reference signal configuration.

In some example embodiments, the first device may comprise a sensing receiver, the second device may comprise a sensing transmitter, the third device may comprise a session management function and the reference signal may be a sensing reference signal.

In a second aspect, disclosed is a second device in a radio access network. The second device may include at least one processor and at least one memory. The at least one memory may include computer program code, and the at least one memory and the computer program code may be configured to, with the at least one processor, cause the second device to perform: obtaining information indicative of one or more reference signal configurations and associated events, wherein the one or more reference signal configurations may be associated with transmission of reference signal from the second device to a first device in the radio access network and the one or more reference signal configurations may comprise at least a first reference signal configuration; and transmitting to the first device, the reference signal using the first reference signal configuration.

In some example embodiments, the at least one memory and the computer program code may be further configured to, with the at least one processor, cause the second device to further perform: receiving from a third device, a second reference signal configuration associated with the transmission of the reference signal from the second device to the first device.

In some example embodiments, the at least one memory and the computer program code may be further configured to, with the at least one processor, cause the second device to further perform: receiving from the first device, an indication indicative of one or more events; and responsive to receiving the indication, transmitting to the first device, the reference signal using the second reference signal configuration.

In some example embodiments, the at least one memory and the computer program code may be further configured to, with the at least one processor, cause the second device to further perform: receiving from the third device, a request to transmit the reference signal using the second reference signal configuration; and transmitting to the first device, the reference signal using the second reference signal configuration.

In some example embodiments, the at least one memory and the computer program code may be further configured to, with the at least one processor, cause the second device to further perform: receiving from the third device, a request for a second reference signal configuration associated with the transmission of the reference signal from the second device to the first device; transmitting to the third device, the second reference signal configuration; and transmitting to the first device, the reference signal using the second reference signal configuration.

In some example embodiments, the at least one memory and the computer program code may be further configured to, with the at least one processor, cause the second device to further perform: stopping transmitting to the first device, the reference signal using the second reference signal configuration responsive to receiving from the first device, an indication indicative of one or more events associated with the first reference signal configuration, or receiving from the third device, an indication to stop the transmission of the reference signal using the second reference signal configuration.

In some example embodiments, the first device may comprise a sensing receiver, the second device may comprise a sensing transmitter, the third device may comprise a session management function and the reference signal may be a sensing reference signal.

In a third aspect, disclosed is a third device. The third device may include at least one processor and at least one memory. The at least one memory may include computer program code, and the at least one memory and the computer program code may be configured to, with the at least one processor, cause the third device to perform: transmitting to a first device in a radio access network, information indicative of one or more reference signal configurations and associated events, wherein the one or more reference signal configurations may be associated with transmission of reference signal from a second device in the radio access network to the first device.

In some example embodiments, the at least one memory and the computer program code may be further configured to, with the at least one processor, cause the third device to further perform: receiving from the first device, a capability of the first device, the capability comprising at least one of the following: a computing capability, a machine learning capability, at least one executable sensing task, device category, and power status, wherein the information may be determined based at least on the received capability.

In some example embodiments, the one or more reference signal configurations may comprise a second reference signal configuration associated with the transmission of the reference signal from the second device in the radio access network to the first device.

In some example embodiments, the at least one memory and the computer program code may be further configured to, with the at least one processor, cause the third device to further perform: transmitting to the first device and the second device, respectively, a second reference signal configuration associated with the transmission of the reference signal from the second device to the first device.

In some example embodiments, the at least one memory and the computer program code may be further configured to, with the at least one processor, cause the third device to further perform: receiving from the first device, an indication indicative of one or more events; and responsive to receiving the indication, transmitting to the second device, a request to transmit the reference signal using the second reference signal configuration.

In some example embodiments, the at least one memory and the computer program code may be further configured to, with the at least one processor, cause the third device to further perform: receiving from the first device, an indication indicative of one or more events; responsive to receiving the indication, transmitting to the second device, a request for a second reference signal configuration associated with the transmission of the reference signal from the second device to the first device; receiving from the second device, the second reference signal configuration; and transmitting to the first device, the second reference signal configuration.

In some example embodiments, the at least one memory and the computer program code may be further configured to, with the at least one processor, cause the third device to further perform: receiving from the first device, an indication indicative of one or more events; and responsive to receiving the indication, transmitting to the first device and the second device, respectively, a second reference signal configuration associated with the transmission of the reference signal from the second device to the first device.

In some example embodiments, the at least one memory and the computer program code may be further configured to, with the at least one processor, cause the third device to further perform: receiving from the first device, a result of measurement performed on the reference signal using the second reference signal configuration; transmitting to the first device, an indication to stop the measurement on the reference signal using the second reference signal configuration upon detecting one or more events associated with a first reference signal configuration based at least on the result of the measurement; and transmitting to the second device, an indication to stop the transmission of the reference signal using the second reference signal configuration.

In some example embodiments, the first device may comprise a sensing receiver, the second device may comprise a sensing transmitter, the third device may comprise a session management function and the reference signal may be a sensing reference signal.

In a fourth aspect, disclosed is a method performed by a first device in a radio access network. The method may comprise: receiving from a third device, information indicative of one or more reference signal configurations and associated events, wherein the one or more reference signal configurations may be associated with transmission of a reference signal from the second device in the radio access network to the first device; and detecting one or more events based at least on the one or more reference signal configurations.

In some example embodiments, the method may further comprise: transmitting to the third device, a capability of the first device, wherein the capability may comprise at least one of the following: a computing capability, a machine learning capability, at least one executable sensing task, device category, and power status.

In some example embodiments, the one or more reference signal configurations may comprise a first reference signal configuration, and the method may further comprise:

performing measurement on the reference signal received from the second device using the first reference signal configuration, wherein the one or more events may be detected based on the measurement.

In some example embodiments, the method may further comprise: receiving from the third device, a second reference signal configuration associated with the transmission of the reference signal from the second device to the first device.

In some example embodiments, the one or more reference signal configurations may comprise a second reference signal configuration associated with the transmission of the reference signal from the second device to the first device.

In some example embodiments, the method may further comprise: transmitting to the second device or the third device, an indication indicative of the one or more events upon detecting the one or more events; and performing the measurement on the reference signal received from the second device using the second reference signal configuration.

In some example embodiments, the method may further comprise: transmitting to the third device, an indication indicative of the one or more events upon detecting the one or more events; receiving from the third device, a second reference signal configuration associated with the transmission of the reference signal from the second device to the first device; and performing the measurement on the reference signal received from the second device using the second reference signal configuration.

In some example embodiments, the method may further comprise: reporting to the third device, a result of the measurement performed on the reference signal using the second reference signal configuration.

In some example embodiments, the method may further comprise: stopping the measurement on the reference signal using the second reference signal configuration upon detecting one or more events associated with the first reference signal configuration, or receiving from the third device, an indication to stop the measurement on the reference signal using the second reference signal configuration, wherein the one or more events associated with the first reference signal configuration may be detected based on at least one of the first reference signal configuration and the second reference signal configuration.

In some example embodiments, the method may further comprise: stopping the measurement on the reference signal using the first reference signal configuration upon detecting the one or more events.

In some example embodiments, the method may further comprise: resuming the measurement on the reference signal using the first reference signal configuration upon detecting one or more events associated with the first reference signal configuration, or receiving from the third device, the indication to stop the measurement on the reference signal using the second reference signal configuration.

In some example embodiments, the first device may comprise a sensing receiver, the second device may comprise a sensing transmitter, the third device may comprise a session management function and the reference signal may be a sensing reference signal.

In a fifth aspect, disclosed is a method performed by a second device in a radio access network. The method may comprise: obtaining information indicative of one or more reference signal configurations and associated events, wherein the one or more reference signal configurations may be associated with transmission of reference signal from the second device to a first device in the radio access network and the one or more reference signal configurations may comprise at least a first reference signal configuration; and transmitting to the first device, the reference signal using the first reference signal configuration.

In some example embodiments, the method may further comprise: receiving from a third device, a second reference signal configuration associated with the transmission of the reference signal from the second device to the first device.

In some example embodiments, the method may further comprise: receiving from the first device, an indication indicative of one or more events; and responsive to receiving the indication, transmitting to the first device, the reference signal using the second reference signal configuration.

In some example embodiments, the method may further comprise: receiving from the third device, a request to transmit the reference signal using the second reference signal configuration; and transmitting to the first device, the reference signal using the second reference signal configuration.

In some example embodiments, the method may further comprise: receiving from the third device, a request for a second reference signal configuration associated with the transmission of the reference signal from the second device to the first device; transmitting to the third device, the second reference signal configuration; and transmitting to the first device, the reference signal using the second reference signal configuration.

In some example embodiments, the method may further comprise: stopping transmitting to the first device, the reference signal using the second reference signal configuration responsive to receiving from the first device, an indication indicative of one or more events associated with the first reference signal configuration, or receiving from the third device, an indication to stop the transmission of the reference signal using the second reference signal configuration.

In some example embodiments, the first device may comprise a sensing receiver, the second device may comprise a sensing transmitter, the third device may comprise a session management function and the reference signal may be a sensing reference signal.

In a sixth aspect, disclosed is a method performed by a third device. The method may comprise: transmitting to a first device in a radio access network, information indicative of one or more reference signal configurations and associated events, wherein the one or more reference signal configurations may be associated with transmission of reference signal from a second device in the radio access network to the first device.

In some example embodiments, the method may further comprise: receiving from the first device, a capability of the first device, the capability comprising at least one of the following: a computing capability, a machine learning capability, at least one executable sensing task, device category, and power status, wherein the information may be determined based at least on the received capability.

In some example embodiments, the one or more reference signal configurations may comprise a second reference signal configuration associated with the transmission of the reference signal from the second device in the radio access network to the first device.

In some example embodiments, the method may further comprise: transmitting to the first device and the second device, respectively, a second reference signal configuration associated with the transmission of the reference signal from the second device to the first device.

In some example embodiments, the method may further comprise: receiving from the first device, an indication indicative of one or more events; and responsive to receiving the indication, transmitting to the second device, a request to transmit the reference signal using the second reference signal configuration.

In some example embodiments, the method may further comprise: receiving from the first device, an indication indicative of one or more events; responsive to receiving the indication, transmitting to the second device, a request for a second reference signal configuration associated with the transmission of the reference signal from the second device to the first device; receiving from the second device, the second reference signal configuration; and transmitting to the first device, the second reference signal configuration.

In some example embodiments, the method may further comprise: receiving from the first device, an indication indicative of one or more events; and responsive to receiving the indication, transmitting to the first device and the second device, respectively, a second reference signal configuration associated with the transmission of the reference signal from the second device to the first device.

In some example embodiments, the method may further comprise: receiving from the first device, a result of measurement performed on the reference signal using the second reference signal configuration; transmitting to the first device, an indication to stop the measurement on the reference signal using the second reference signal configuration upon detecting one or more events associated with a first reference signal configuration based at least on the result of the measurement; and transmitting to the second device, an indication to stop the transmission of the reference signal using the second reference signal configuration.

In some example embodiments, the first device may comprise a sensing receiver, the second device may comprise a sensing transmitter, the third device may comprise a session management function and the reference signal may be a sensing reference signal.

In a seventh aspect, disclosed is an apparatus. The apparatus as a first device in a radio access network may comprise: means for receiving from a third device, information indicative of one or more reference signal configurations and associated events, wherein the one or more reference signal configurations may be associated with transmission of a reference signal from the second device in the radio access network to the first device; and means for detecting one or more events based at least on the one or more reference signal configurations.

In some example embodiments, the apparatus may further comprise: means for transmitting to the third device, a capability of the first device, wherein the capability may comprise at least one of the following: a computing capability, a machine learning capability, at least one executable sensing task, device category, and power status.

In some example embodiments, the one or more reference signal configurations may comprise a first reference signal configuration, and the apparatus may further comprise: means for performing measurement on the reference signal received from the second device using the first reference signal configuration, wherein the one or more events may be detected based on the measurement.

In some example embodiments, the apparatus may further comprise: means for receiving from the third device, a second reference signal configuration associated with the transmission of the reference signal from the second device to the first device.

In some example embodiments, the one or more reference signal configurations may comprise a second reference signal configuration associated with the transmission of the reference signal from the second device to the first device.

In some example embodiments, the apparatus may further comprise: means for transmitting to the second device or the third device, an indication indicative of the one or more events upon detecting the one or more events; and means for performing the measurement on the reference signal received from the second device using the second reference signal configuration.

In some example embodiments, the apparatus may further comprise: means for transmitting to the third device, an indication indicative of the one or more events upon detecting the one or more events; means for receiving from the third device, a second reference signal configuration associated with the transmission of the reference signal from the second device to the first device; and means for performing the measurement on the reference signal received from the second device using the second reference signal configuration.

In some example embodiments, the apparatus may further comprise: means for reporting to the third device, a result of the measurement performed on the reference signal using the second reference signal configuration.

In some example embodiments, the apparatus may further comprise: means for stopping the measurement on the reference signal using the second reference signal configuration upon detecting one or more events associated with the first reference signal configuration, or receiving from the third device, an indication to stop the measurement on the reference signal using the second reference signal configuration, wherein the one or more events associated with the first reference signal configuration may be detected based on at least one of the first reference signal configuration and the second reference signal configuration.

In some example embodiments, the apparatus may further comprise: means for stopping the measurement on the reference signal using the first reference signal configuration upon detecting the one or more events.

In some example embodiments, the apparatus may further comprise: means for resuming the measurement on the reference signal using the first reference signal configuration upon detecting one or more events associated with the first reference signal configuration, or receiving from the third device, the indication to stop the measurement on the reference signal using the second reference signal configuration.

In some example embodiments, the first device may comprise a sensing receiver, the second device may comprise a sensing transmitter, the third device may comprise a session management function and the reference signal may be a sensing reference signal.

In an eighth aspect, disclosed is an apparatus. The apparatus as a second device in a radio access network may comprise: means for obtaining information indicative of one or more reference signal configurations and associated events, wherein the one or more reference signal configurations may be associated with transmission of reference signal from the second device to a first device in the radio access network and the one or more reference signal configurations may comprise at least a first reference signal configuration; and means for transmitting to the first device, the reference signal using the first reference signal configuration.

In some example embodiments, the apparatus may further comprise: means for receiving from a third device, a second reference signal configuration associated with the transmission of the reference signal from the second device to the first device.

In some example embodiments, the apparatus may further comprise: means for receiving from the first device, an indication indicative of one or more events; and means for responsive to receiving the indication, transmitting to the first device, the reference signal using the second reference signal configuration.

In some example embodiments, the apparatus may further comprise: means for receiving from the third device, a request to transmit the reference signal using the second reference signal configuration; and means for transmitting to the first device, the reference signal using the second reference signal configuration.

In some example embodiments, the apparatus may further comprise: means for receiving from the third device, a request for a second reference signal configuration associated with the transmission of the reference signal from the second device to the first device; means for transmitting to the third device, the second reference signal configuration; and means for transmitting to the first device, the reference signal using the second reference signal configuration.

In some example embodiments, the apparatus may further comprise: means for stopping transmitting to the first device, the reference signal using the second reference signal configuration responsive to receiving from the first device, an indication indicative of one or more events associated with the first reference signal configuration, or receiving from the third device, an indication to stop the transmission of the reference signal using the second reference signal configuration.

In some example embodiments, the first device may comprise a sensing receiver, the second device may comprise a sensing transmitter, the third device may comprise a session management function and the reference signal may be a sensing reference signal.

In a ninth aspect, disclosed is an apparatus. The apparatus as a third device may comprise: means for transmitting to a first device in a radio access network, information indicative of one or more reference signal configurations and associated events, wherein the one or more reference signal configurations may be associated with transmission of reference signal from a second device in the radio access network to the first device.

In some example embodiments, the apparatus may further comprise: means for receiving from the first device, a capability of the first device, the capability comprising at least one of the following: a computing capability, a machine learning capability, at least one executable sensing task, device category, and power status, wherein the information may be determined based at least on the received capability.

In some example embodiments, the one or more reference signal configurations may comprise a second reference signal configuration associated with the transmission of the reference signal from the second device in the radio access network to the first device.

In some example embodiments, the apparatus may further comprise: means for transmitting to the first device and the second device, respectively, a second reference signal configuration associated with the transmission of the reference signal from the second device to the first device.

In some example embodiments, the apparatus may further comprise: means for receiving from the first device, an indication indicative of one or more events; and means for responsive to receiving the indication, transmitting to the second device, a request to transmit the reference signal using the second reference signal configuration.

In some example embodiments, the apparatus may further comprise: means for receiving from the first device, an indication indicative of one or more events; means for responsive to receiving the indication, transmitting to the second device, a request for a second reference signal configuration associated with the transmission of the reference signal from the second device to the first device; means for receiving from the second device, the second reference signal configuration; and means for transmitting to the first device, the second reference signal configuration.

In some example embodiments, the apparatus may further comprise: means for receiving from the first device, an indication indicative of one or more events; and means for responsive to receiving the indication, transmitting to the first device and the second device, respectively, a second reference signal configuration associated with the transmission of the reference signal from the second device to the first device.

In some example embodiments, the apparatus may further comprise: means for receiving from the first device, a result of measurement performed on the reference signal using the second reference signal configuration; means for transmitting to the first device, an indication to stop the measurement on the reference signal using the second reference signal configuration upon detecting one or more events associated with a first reference signal configuration based at least on the result of the measurement; and means for transmitting to the second device, an indication to stop the transmission of the reference signal using the second reference signal configuration.

In some example embodiments, the first device may comprise a sensing receiver, the second device may comprise a sensing transmitter, the third device may comprise a session management function and the reference signal may be a sensing reference signal.

In a tenth aspect, a computer readable medium is disclosed. The computer readable medium may include instructions stored thereon for causing a first device in a radio access network to perform: receiving from a third device, information indicative of one or more reference signal configurations and associated events, wherein the one or more reference signal configurations may be associated with transmission of a reference signal from the second device in the radio access network to the first device; and detecting one or more events based at least on the one or more reference signal configurations.

In some example embodiments, the computer readable medium may further include instructions stored thereon for causing the first device to further perform: transmitting to the third device, a capability of the first device, wherein the capability may comprise at least one of the following: a computing capability, a machine learning capability, at least one executable sensing task, device category, and power status.

In some example embodiments, the one or more reference signal configurations may comprise a first reference signal configuration, and the computer readable medium may further include instructions stored thereon for causing the first device to further perform: performing measurement on the reference signal received from the second device using the first reference signal configuration, wherein the one or more events may be detected based on the measurement.

In some example embodiments, the computer readable medium may further include instructions stored thereon for causing the first device to further perform: receiving from the third device, a second reference signal configuration associated with the transmission of the reference signal from the second device to the first device.

In some example embodiments, the one or more reference signal configurations may comprise a second reference signal configuration associated with the transmission of the reference signal from the second device to the first device.

In some example embodiments, the computer readable medium may further include instructions stored thereon for causing the first device to further perform: transmitting to the second device or the third device, an indication indicative of the one or more events upon detecting the one or more events; and performing the measurement on the reference signal received from the second device using the second reference signal configuration.

In some example embodiments, the computer readable medium may further include instructions stored thereon for causing the first device to further perform: transmitting to the third device, an indication indicative of the one or more events upon detecting the one or more events; receiving from the third device, a second reference signal configuration associated with the transmission of the reference signal from the second device to the first device; and performing the measurement on the reference signal received from the second device using the second reference signal configuration.

In some example embodiments, the computer readable medium may further include instructions stored thereon for causing the first device to further perform: reporting to the third device, a result of the measurement performed on the reference signal using the second reference signal configuration.

In some example embodiments, the computer readable medium may further include instructions stored thereon for causing the first device to further perform: stopping the measurement on the reference signal using the second reference signal configuration upon detecting one or more events associated with the first reference signal configuration, or receiving from the third device, an indication to stop the measurement on the reference signal using the second reference signal configuration, wherein the one or more events associated with the first reference signal configuration may be detected based on at least one of the first reference signal configuration and the second reference signal configuration.

In some example embodiments, the computer readable medium may further include instructions stored thereon for causing the first device to further perform: stopping the measurement on the reference signal using the first reference signal configuration upon detecting the one or more events.

In some example embodiments, the computer readable medium may further include instructions stored thereon for causing the first device to further perform: resuming the measurement on the reference signal using the first reference signal configuration upon detecting one or more events associated with the first reference signal configuration, or receiving from the third device, the indication to stop the measurement on the reference signal using the second reference signal configuration.

In some example embodiments, the first device may comprise a sensing receiver, the second device may comprise a sensing transmitter, the third device may comprise a session management function and the reference signal may be a sensing reference signal.

In an eleventh aspect, a computer readable medium is disclosed. The computer readable medium may include instructions stored thereon for causing a second device in a radio access network to perform: obtaining information indicative of one or more reference signal configurations and associated events, wherein the one or more reference signal configurations may be associated with transmission of reference signal from the second device to a first device in the radio access network and the one or more reference signal configurations may comprise at least a first reference signal configuration; and transmitting to the first device, the reference signal using the first reference signal configuration.

In some example embodiments, the computer readable medium may further include instructions stored thereon for causing the second device to further perform: receiving from a third device, a second reference signal configuration associated with the transmission of the reference signal from the second device to the first device.

In some example embodiments, the computer readable medium may further include instructions stored thereon for causing the second device to further perform: receiving from the first device, an indication indicative of one or more events; and responsive to receiving the indication, transmitting to the first device, the reference signal using the second reference signal configuration.

In some example embodiments, the computer readable medium may further include instructions stored thereon for causing the second device to further perform: receiving from the third device, a request to transmit the reference signal using the second reference signal configuration; and transmitting to the first device, the reference signal using the second reference signal configuration.

In some example embodiments, the computer readable medium may further include instructions stored thereon for causing the second device to further perform: receiving from the third device, a request for a second reference signal configuration associated with the transmission of the reference signal from the second device to the first device; transmitting to the third device, the second reference signal configuration; and transmitting to the first device, the reference signal using the second reference signal configuration.

In some example embodiments, the computer readable medium may further include instructions stored thereon for causing the second device to further perform: stopping transmitting to the first device, the reference signal using the second reference signal configuration responsive to receiving from the first device, an indication indicative of one or more events associated with the first reference signal configuration, or receiving from the third device, an indication to stop the transmission of the reference signal using the second reference signal configuration.

In some example embodiments, the first device may comprise a sensing receiver, the second device may comprise a sensing transmitter, the third device may comprise a session management function and the reference signal may be a sensing reference signal.

In a twelfth aspect, a computer readable medium is disclosed. The computer readable medium may include instructions stored thereon for causing a third device to perform: transmitting to a first device in a radio access network, information indicative of one or more reference signal configurations and associated events, wherein the one or more reference signal configurations may be associated with transmission of reference signal from a second device in the radio access network to the first device.

In some example embodiments, the computer readable medium may further include instructions stored thereon for causing the third device to further perform: receiving from the first device, a capability of the first device, the capability comprising at least one of the following: a computing capability, a machine learning capability, at least one executable sensing task, device category, and power status, wherein the information may be determined based at least on the received capability.

In some example embodiments, the one or more reference signal configurations may comprise a second reference signal configuration associated with the transmission of the reference signal from the second device in the radio access network to the first device.

In some example embodiments, the computer readable medium may further include instructions stored thereon for causing the third device to further perform: transmitting to the first device and the second device, respectively, a second reference signal configuration associated with the transmission of the reference signal from the second device to the first device.

In some example embodiments, the computer readable medium may further include instructions stored thereon for causing the third device to further perform: receiving from the first device, an indication indicative of one or more events; and responsive to receiving the indication, transmitting to the second device, a request to transmit the reference signal using the second reference signal configuration.

In some example embodiments, the computer readable medium may further include instructions stored thereon for causing the third device to further perform: receiving from the first device, an indication indicative of one or more events; responsive to receiving the indication, transmitting to the second device, a request for a second reference signal configuration associated with the transmission of the reference signal from the second device to the first device; receiving from the second device, the second reference signal configuration; and transmitting to the first device, the second reference signal configuration.

In some example embodiments, the computer readable medium may further include instructions stored thereon for causing the third device to further perform: receiving from the first device, an indication indicative of one or more events; and responsive to receiving the indication, transmitting to the first device and the second device, respectively, a second reference signal configuration associated with the transmission of the reference signal from the second device to the first device.

In some example embodiments, the computer readable medium may further include instructions stored thereon for causing the third device to further perform: receiving from the first device, a result of measurement performed on the reference signal using the second reference signal configuration; transmitting to the first device, an indication to stop the measurement on the reference signal using the second reference signal configuration upon detecting one or more events associated with a first reference signal configuration based at least on the result of the measurement; and transmitting to the second device, an indication to stop the transmission of the reference signal using the second reference signal configuration.

In some example embodiments, the first device may comprise a sensing receiver, the second device may comprise a sensing transmitter, the third device may comprise a session management function and the reference signal may be a sensing reference signal.

Other features and advantages of the example embodiments of the present disclosure will also be apparent from the following description of specific embodiments when read in conjunction with the accompanying drawings, which illustrate, by way of example, the principles of example embodiments of the present disclosure.

### BRIEF DESCRIPTION OF THE DRAWINGS

Some example embodiments will now be described, by way of non-limiting examples, with reference to the accompanying drawings.

FIG. 1 shows an exemplary scenario to which the example embodiments of the present disclosure may be implemented.

FIG. 2 shows an exemplary sequence diagram for hierarchical measurement mechanism according to the example embodiments of the present disclosure.

FIG. 3 shows a flow chart illustrating an example method 300 for hierarchical measurement mechanism according to the example embodiments of the present disclosure.

FIG. 4 shows a flow chart illustrating an example method 400 for hierarchical measurement mechanism according to the example embodiments of the present disclosure.

FIG. 5 shows a flow chart illustrating an example method 500 for hierarchical measurement mechanism according to the example embodiments of the present disclosure.

FIG. 6 shows a block diagram illustrating an example device 600 for hierarchical measurement mechanism according to the example embodiments of the present disclosure.

FIG. 7 shows a block diagram illustrating an example device 700 for hierarchical measurement mechanism according to the example embodiments of the present disclosure.

FIG. 8 shows a block diagram illustrating an example device 800 for hierarchical measurement mechanism according to the example embodiments of the present disclosure.

FIG. 9 shows a block diagram illustrating an example apparatus 900 for hierarchical measurement mechanism according to the example embodiments of the present disclosure.

FIG. 10 shows a block diagram illustrating an example apparatus 1000 for hierarchical measurement mechanism according to the example embodiments of the present disclosure.

FIG. 11 shows a block diagram illustrating an example apparatus 1100 for hierarchical measurement mechanism according to the example embodiments of the present disclosure.

Throughout the drawings, same or similar reference numbers indicate same or similar elements. A repetitive description on the same elements would be omitted.

### DETAILED DESCRIPTION

Herein below, some example embodiments are described in detail with reference to the accompanying drawings. The following description includes specific details for the purpose of providing a thorough understanding of various concepts. However, it will be apparent to those skilled in the art that these concepts may be practiced without these specific details. In some instances, well known circuits, techniques and components are shown in block diagram form to avoid obscuring the described concepts and features.

Example embodiments of the present disclosure provide a hierarchical measurement mechanism. According to the example embodiments of the present disclosure, the hierarchical measurement mechanism for JCAS may reduce device complexity, e.g. measurement complexity, computing complexity, and adverse impact on communication performance.

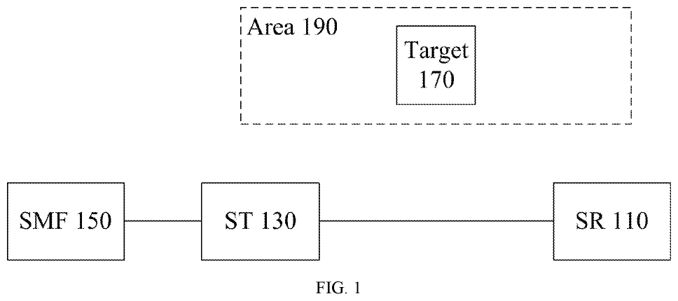

FIG. 1 shows an exemplary scenario to which the example embodiments of the present disclosure may be implemented. Referring to the FIG. 1, a SR 110 may represent any SR in a wireless communication network, a sensing transmitter (ST) 130 may represent any ST in the wireless communication network, and a sensing management function (SMF) 150 may be a sensing management function entity associated with the SR 110 and the ST 130.

The SMF 150 may be a part of access and mobility management function (AMF), location management function (LMF), or a sensing related function entity at network side or at user equipment (UE) side. The SR 110 and/or the ST 130 may be a part of UE or base station (BS). In a case where the wireless communication network is a wireless local area network (WLAN), the SMF 150 may be a part of a access point (AP), a station (STA), a multiple-AP controller, or a sensing related function entity at network side or at UE side, and The SR 110 and/or the ST 130 may be a part of a STA or an AP. It may be appreciated that the SR 110 and the ST 130 are in a radio access network (RAN). The SR 110, the ST 130 and/or the SMF 150 may be located at separate devices or an identical device but serving different functions logically.

The SMF 150 can control a sensing procedure involved in at least one SR, e.g. the SR 110 and at least one ST, e.g. the ST 130. The SMF 150 can indicate the ST 130 to transmit an SEN-RS. Based on the measurement over the SEN-RS, e.g. the channel state information (CSI), the SR 110 can estimate for example range, angle of arrival (AoA), Doppler shift, and/or range-Doppler profile based on the sensing measurement.

In the example embodiments of the present disclosure, the SMF 150 may divide a sensing task into different levels of sensing subtasks according to the sensing-related capability of the SR 110 and the sensing task requirements. For example, if a sensing task is to measure a target 170, the sensing task may be divided into a device-level sensing subtask such as intrusion detection, for example, detecting whether the target 170 is within an interested area 190, and a network-level sensing task such as tracking the target 170 and analyzing behavior of the target 170 if the target 170 is within an area 190. The device-level sensing subtask generally requires low sensing resources including RS resources, computing resources, power resources, etc. while the network-level sensing subtask can handle more complex sensing task with high requirements on sensing resources.

For example, in the case of home healthcare and safety sensing, the device-level sensing subtasks can be a simple moving target detection which can be implemented based on range/angle/Doppler measurement without high sensing resource requirement. The network-level sensing subtask can be an advanced task to track and analyze the activity and/or behaviors of the sensing target 170, which would have high requirements on sensing resources or joint sensing measurement report from multiple SRs.

The device-level sensing subtask(s) can be located at the ST 130 side and the network-level sensing subtask(s) can be located at the network side, e.g., the SMF 150 or network data analysis function (NWDAF) based on the sensing related capability report from the SR 110 and the sensing requirements.

Different levels of sensing subtasks may be performed using different RS configurations. For example, a coarse-grained RS configuration can not only be used to measure the range, angle and/or Doppler information of the target 170 with low resolution and/or ambiguity, but also can be used to sense simple environment change and/or target behaviors. A fine-grained RS configuration may be used to achieve high resolution and ambiguity for sensing measurement e.g. range, angle, Doppler etc. and advanced sensing tasks. For this, high complexity and high power consumption on RS measurement and processing would be involved, which may cause additional power consumption and communication overhead for sensing measurement report.

The coarse-grained RS configuration may comprise less resources of RS in time/frequency/spatial/coding domain or larger transmission period of the RS pattern than the fine-grained SEN-RS configuration. The coarse-grained RS configuration can be but not limited to a subset of the fine-grained RS configuration. For example, in a sensing frame of a RS, the time and/or frequency resources for the coarse-grained RS configuration may be a part of, partly overlap, or different from the time and/or frequency resources for the fine-grained RS configuration. Alternatively, the coarse-grained RS configuration can have the same configuration with the fine-grained RS configuration.

FIG. 2 shows an exemplary sequence diagram for hierarchical measurement mechanism according to the example embodiments of the present disclosure.

Referring to the FIG. 2, in an embodiment, the SR 110 may transmit, to the SMF 150, a capability 212 of the SR 110. The capability 212 may include at least one of the following: a computing capability, an ML capability, at least one executable sensing task, device category, and power status. The at least one executable sensing task may be at least one sensing task the SR 110 is able to execute, for example, range/angle/Doppler measurement, line of sight (LOS) estimation, intrusion detection or/and proximity perception etc. The device category may indicate the SR 110 is e.g. a high power device which will consume more power or a low power device consuming less power, etc. The power status may indicate e.g. remaining power in the SR 110.

The SMF 150 may transmit to the SR 110 information 254 indicative of one or more RS configurations and associated events. The one or more RS configurations may be associated with transmission of RS 232 from the ST 130 to the SR 110. Thus, receiving the information 254, for example, in an operation 216, the SR 110 may detect one or more events based at least on the one or more RS configurations. The RS 232 may be for example the SEN-RS. In an embodiment, information 254 may be determined based at least on the received capability 212.

In an embodiment, the one or more RS configurations may comprise a first RS configuration 256. The first RS configuration 256 may be, for example, the coarse-grained RS configuration. The one or more events associated with the first RS configuration 256 may be, for example, the target 170 outside the area 190.

The ST 130 may obtain the information 254 indicative of the one or more RS configurations and associated events. The one or more RS configurations may be associated with the transmission of the RS 232 from the ST 130 to the SR 110. In an embodiment, the ST 130 may receive the information 254 from the SMF 150. Alternatively, the ST 130 may obtain the information 254 from a device other than the SMF 150 or determine the information 254 by itself and transmit the information 254 to the SMF 150. In an embodiment, the one or more RS configurations may comprise the first RS configuration 256.

After obtaining the first RS configuration 256, the ST 130 may transmit, to the SR 110, the RS 232 using the first RS configuration 256, and in an operation 214 the SR 110 may perform measurement on the RS 232 received from the ST 130 using the first RS configuration 256.

In the operation 216, the SR 110 may detect the one or more events based on the measurement performed in the operation 214. The one or more events may be, for example, the target 170 entering the area 190 shown in the FIG. 1. In an embodiment, the one or more events can be defined as whether or not a sensing measurement and/or a sensing result meets certain condition. For example, the one or more events can be that fluctuation of CSI, e.g. received signal strength indicator (RSSI) over a given time, which may be measured based on the first RS configuration 256, is larger than a certain threshold. For example, the one or more events may be that at least a moving target is detected based on the measurement over the first RS configuration 256. The one or more events detected based on the device-level sensing subtask can trigger execution of network-level sensing subtask, which will be described later. For example, the SR 110 can perform CSI measurement in sensing frames and obtain the Doppler shift information of the target 170 based on the CSI measurement. If the target 170 is detected in the area 190 based on observation of Doppler shift information for the target 170, the one or more events can be detected, and the measurement over the fine-grained RS configuration will be triggered.

Thus, if the SR 110 has not detected the one or more events, the SR 110 would not require to execute the network-level sensing subtask. In this case, the first RS configuration 256 is used so as to reduce the resource overhead and the complexity of the SR 110 involved in measurement, report and computing. If the SR 110 detects the one or more events, the fine-grained RS configuration will be used. In this case, the SR 110 may report the measurement, e.g. CSI, range-Doppler profile, etc. to the SMF 150 for the execution of the network-level sensing subtask.

The SMF 150 may transmit a second RS configuration 258, which may be, for example, the fine-grained RS configuration and be associated with the transmission of the RS 232 from the ST 130 to the SR 110, to the SR 110 and the ST 130, respectively. Alternatively, in an embodiment, the SMF 150 may transmit to the ST 130, a request for the second RS configuration 258 and receive the second RS configuration 258 from the ST 130.

In an embodiment, the one or more RS configurations indicated by the information 254 may comprise the second RS configuration 258. Moreover, the one or more reference signal configurations indicated by the information 254 obtained by the ST 130 may also comprise the second RS configuration 258.

In a case where the SR 110 receives the information 254 indicative of both the first RS configuration 256 and the second RS configuration 258, in the operation 214 the SR 110 may perform measurement on the RS 232 using the first RS configuration 256 but not using the second RS configuration 258 during an initial phase, e.g. before detecting the one or more events in the operation 216. Further, in a case where the ST 130 receives the information 254 indicative of both the first RS configuration 256 and the second RS configuration 258, the ST 130 may transmit to the SR 110 the RS 232 using the first RS configuration 256 but not using the second RS configuration 258 during the initial phase, e.g. before being notified to transmit the RS 232 using the second RS configuration 258.

In an embodiment, the SR 110 may transmit, to the ST 130, an indication 218 indicative of the one or more events upon detecting the one or more events in the operation 216. In this embodiment both the SR 110 and the ST 130 has the second RS configuration 258, responsive to receiving the indication 218, the ST 130 may transmit, to the SR 110, the RS 232 using the second RS configuration 258, and in an operation 220, the SR 110 may perform the measurement on the RS 232 received from the ST 130 using the second RS configuration 258.

Alternatively, in an embodiment, the SR 110 may transmit, to the SMF 150, the indication 218 indicative of the one or more events upon detecting the one or more events in the operation 216. In this embodiment both the SR 110 and the ST 130 has the second RS configuration 258, responsive to receiving the indication 218, the SMF 150 may transmit, to the ST 130, a request 264 to transmit the RS 232 using the second RS configuration 258. After receiving the request 264, the ST 130 may transmit, to the SR 110, the RS 232 using the second RS configuration 258, and in the operation 220, the SR 110 may perform the measurement on the RS 232 received from the ST 130 using the second RS configuration 258.

Alternatively, in an embodiment, the second RS configuration 258 can be configured at the SR 110 and the ST 130 after the one or more events detected in the operation 216. For example, the SR 110 may transmit, to the SMF 150, the indication 218 indicative of the one or more events upon detecting the one or more events in the operation 216, and responsive to receiving the indication 218, the SMF 150 may transmit, to the SR 110 and the ST 130, respectively, the second RS configuration 258 associated with the transmission of the RS 232 from the ST 130 to the SR 110. Then, the ST 130 may transmit, to the SR 110, the RS 232 using the second RS configuration 258 according to, for example, the request 264 from the SMF 150 or the indication 218 from the SR 110, and in the operation 220, the SR 110 may perform the measurement on the RS 232 received from the ST 130 using the second RS configuration 258.

In this embodiment, alternatively, as an option, responsive to receiving the indication 218, the SMF 150 may transmit to the ST 130, a request for the second RS configuration 258. After receiving the request for the second RS configuration 258, the ST 130 may transmit to the SMF 150, the second RS configuration 258. After receiving the second RS configuration 258 from the ST 130, the SMF 150 may transmit, to the SR 110, the second RS configuration 258. Thus, the ST 130 may transmit to the SR 110, the RS 232 using the second RS configuration 258, and in the operation 220, the SR 110 may perform the measurement on the RS 232 received from the ST 130 using the second RS configuration 258.

In a case where the SR 110 performs the operation 220, the SR 110 may continue performing the operation 214, alternatively, in an operation 226, the SR 110 may stop the measurement on the RS 232 using the first RS configuration 256 upon detecting the one or more events in the operation 216.

In an embodiment, the SR 110 may report, to the SMF 150, a result 222 of the measurement performed on the RS 232 using the second RS configuration 258. For example, the measurement result 222 may be reported to a sensing processing unit, e.g., NWDAF directly or forwarded by the SMF 150. The measurement result 222 can be but not limited to, for example, regarding CSI, RSSI, range, angle, Doppler, range-Doppler profile or other information which can be obtained through the measurement on the RS 232 over the second RS configuration 258. Further, the measurement result 222 can be used to facilitate the execution of the network-level sensing subtask.

In an embodiment, receiving the result 222 of the measurement performed on the RS 232 using the second RS configuration 258, the SMF 150 may transmit to the SR 110, an indication 268 to stop the measurement on the RS 232 using the second RS configuration 258 upon detecting one or more events associated with the first RS configuration 256 based at least on the result 222 of the measurement and transmit to the ST 130, an indication 266 to stop the transmission of the RS 232 using the second RS configuration 258.

Alternatively, in an embodiment, the SR 110 may detect the one or more events associated with the first RS configuration 256 based on at least one of the first RS configuration 256 and the second RS configuration 258. In an operation 224, the SR 110 may stop the measurement on the RS 232 using the second RS configuration 258 upon detecting the one or more events associated with the first RS configuration 256 or receiving from the SMF 150, the indication 268 to stop the measurement on the RS 232 using the second RS configuration 258. As an option, the SR 110 may transmit, to the ST 130, an indication 223 indicative of the one or more events associated with the first RS configuration 256.

In an embodiment, the ST 130 may stop transmitting to the SR 110, the RS 232 using the second RS configuration 258 responsive to receiving from the SR 110, the indication 223 indicative of the one or more events associated with the first RS configuration 256 or receiving from the SMF 150, the indication 266 to stop the transmission of the RS 232 using the second RS configuration 258.

In a case where the SR 110 performs the operation 226 to stop the measurement on the RS 232 using the first RS configuration 256 upon detecting the one or more events in the operation 216, in an operation 228, the SR 110 may resume the measurement on the RS 232 using the first RS configuration 256 upon detecting the one or more events associated with the first RS configuration 256 or receiving from the SMF 150, the indication 268 to stop the measurement on the RS 232 using the second RS configuration 258.

In the example embodiments of the present disclosure, the SR 110 may be included in a first device, the ST 130 may be included in a second device, and the SMF 150 may be included in a third device.

The example embodiments of the present disclosure provide an efficient hierarchical measurement mechanism for JCAS. The example embodiments may reduce the RS resource overhead, the complexity and power consumption of the SR and/or the ST since the second RS configuration will be triggered if the second event is detected based on the device-level sensing subtasks with low RS resource overhead. The example embodiments may also enable reasonable sensing task allocation and RS configuration at device side and network side based on capability of the SR and task requirement. Moreover, the example embodiments may reduce SR device requirement for sensing measurement. In addition, according to the example embodiments sensing resource influence to communication can be reduced.

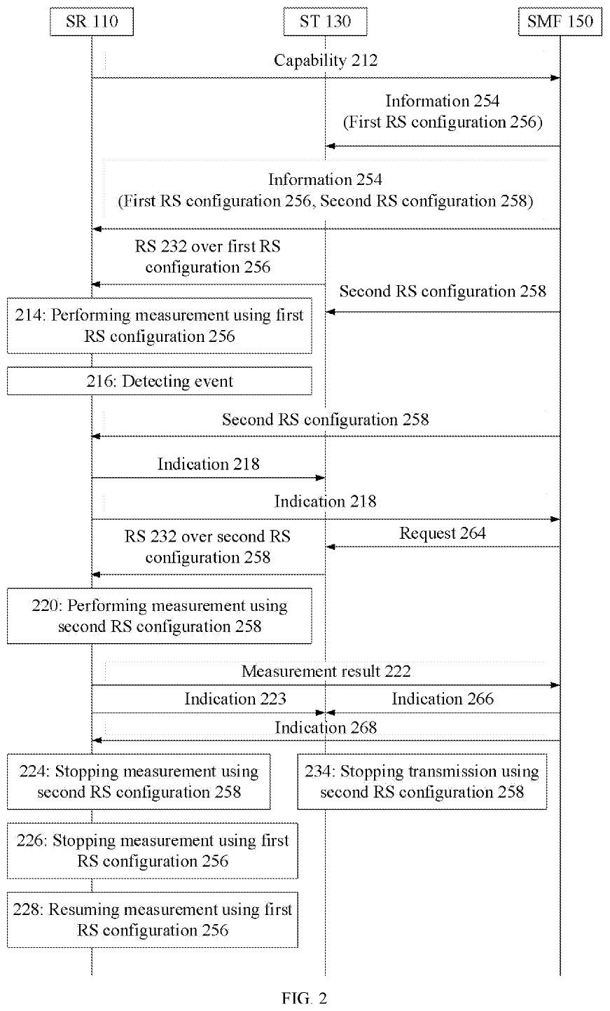

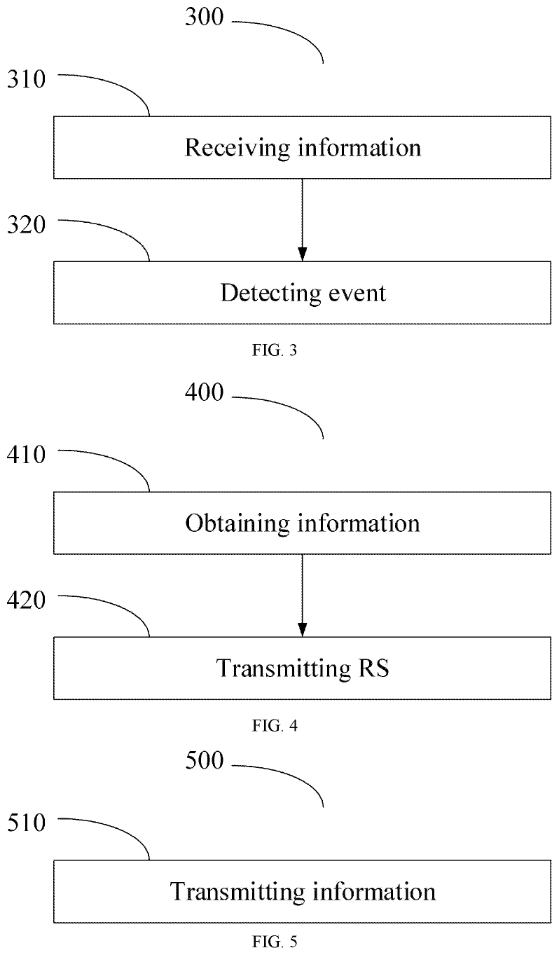

FIG. 3 shows a flow chart illustrating an example method 300 for hierarchical measurement mechanism according to the example embodiments of the present disclosure. The example method 300 may be performed for example at a first device in a RAN comprising the SR 110.

Referring to the FIG. 3, the example method 300 may include an operation 310 of receiving, from a third device, information indicative of one or more RS configurations and associated events, wherein the one or more RS configurations may be associated with transmission of a RS from the second device in the RAN to the first device; and an operation 320 of detecting one or more events based at least on the one or more RS configurations.

Details of the operation 310 have been described in the above descriptions with respect to at least the information 254, and repetitive descriptions thereof are omitted here.

Details of the operation 320 have been described in the above descriptions with respect to at least the operation 216, and repetitive descriptions thereof are omitted here.

In an embodiment, the example method 300 may further include an operation of transmitting to the third device, a capability of the first device, wherein the capability may comprise at least one of the following: a computing capability, an ML capability, at least one executable sensing task, device category, and power status. The more details have been described in the above descriptions with respect to at least the capability 212, and repetitive descriptions thereof are omitted here.

In an embodiment, the one or more reference signal configurations may comprise a first RS configuration the example method 300 may further include an operation of performing measurement on the RS received from the second device using the first RS configuration, and the one or more events may be detected based on the measurement. The more details have been described in the above descriptions with respect to at least the first RS configuration 256, the operation 214 and the operation 216, and repetitive descriptions thereof are omitted here.

In an embodiment, the example method 300 may further include an operation of receiving, from the third device, a second RS configuration associated with the transmission of the RS from the second device to the first device. The more details have been described in the above descriptions with respect to at least the second RS configuration 258, and repetitive descriptions thereof are omitted here.

In an embodiment, the one or more RS configurations may comprise a second RS configuration associated with the transmission of the RS from the second device to the first device. The more details have been described in the above descriptions with respect to at least the second RS configuration 258, and repetitive descriptions thereof are omitted here.

In an embodiment, the example method 300 may further include an operation of transmitting, to the second device or the third device, an indication indicative of the one or more events upon detecting the one or more events, the more details of which have been described in the above descriptions with respect to at least the indication 218, and repetitive descriptions thereof are omitted here; and an operation of performing the measurement on the RS received from the second device using the second RS configuration, the more details of which have been described in the above descriptions with respect to at least the operation 220, and repetitive descriptions thereof are omitted here.

In an embodiment, the example method 300 may further include an operation of transmitting, to the third device, an indication indicative of the one or more events upon detecting the one or more event, the more details of which have been described in the above descriptions with respect to at least the indication 218, and repetitive descriptions thereof are omitted here; an operation of receiving, from the third device, a second RS configuration associated with the transmission of the RS from the second device to the first device, the more details of which have been described in the above descriptions with respect to at least the second RS configuration 258, and repetitive descriptions thereof are omitted here; and an operation of performing the measurement on the RS received from the second device using the second RS configuration, the more details of which have been described in the above descriptions with respect to at least the operation 220, and repetitive descriptions thereof are omitted here.

In an embodiment, the example method 300 may further include an operation of reporting, to the third device, a result of the measurement performed on the RS using the second RS configuration. The more details have been described in the above descriptions with respect to at least the measurement result 222, and repetitive descriptions thereof are omitted here.

In an embodiment, the example method 300 may further include an operation of stopping the measurement on the RS using the second RS configuration upon detecting one or more events associated with the first RS configuration, or receiving from the third device, an indication to stop the measurement on the RS using the second RS configuration, wherein the one or more events associated with the first RS configuration may be detected based on at least one of the first RS configuration and the second RS configuration. The more details have been described in the above descriptions with respect to at least the indication 268 and the operation 224, and repetitive descriptions thereof are omitted here.

In an embodiment, the example method 300 may further include an operation of stopping the measurement on the RS using the first RS configuration upon detecting the one or more events. The more details have been described in the above descriptions with respect to at least the operation 226, and repetitive descriptions thereof are omitted here.

In an embodiment, the example method 300 may further include an operation of resuming the measurement on the RS using the first RS configuration upon detecting one or more events associated with the first RS configuration, or receiving from the third device, the indication to stop the measurement on the RS using the second RS configuration. The more details have been described in the above descriptions with respect to at least the indication 268 and the operation 228, and repetitive descriptions thereof are omitted here.

In an embodiment, the second device may comprise the ST 130, the third device may comprise the SMF 150, and the RS may be an SEN-RS.

FIG. 4 shows a flow chart illustrating an example method 400 for hierarchical measurement mechanism according to the example embodiments of the present disclosure. The example method 400 may be performed for example at a second device in a RAN comprising the ST 130.

Referring to the FIG. 4, the example method 400 may include an operation 410 of obtaining information indicative of one or more RS configurations and associated events, wherein the one or more RS configurations may be associated with transmission of RS from the second device to a first device in the RAN and the one or more RS configurations may comprise at least a first RS configuration; and an operation 420 of transmitting, to the first device, the RS using the first RS configuration.

Details of the operation 410 have been described in the above descriptions with respect to at least the information 254 and the first RS configuration 256, and repetitive descriptions thereof are omitted here.

Details of the operation 420 have been described in the above descriptions with respect to at least the RS 232 and the first RS configuration 256, and repetitive descriptions thereof are omitted here.

In an embodiment, the example method 400 may further include an operation of receiving, from a third device, a second RS configuration associated with the transmission of the RS from the second device to the first device. The more details have been described in the above descriptions with respect to at least the second RS configuration 258, and repetitive descriptions thereof are omitted here.

In an embodiment, the example method 400 may further include an operation of receiving, from the first device, an indication indicative of one or more events, the more details of which have been described in the above descriptions with respect to at least the indication 218, and repetitive descriptions thereof are omitted here; and an operation of responsive to receiving the indication, transmitting to the first device, the RS using the second RS configuration, the more details of which have been described in the above descriptions with respect to at least the RS 232 and the second RS configuration 258, and repetitive descriptions thereof are omitted here.

In an embodiment, the example method 400 may further include an operation of receiving, from the third device, a request to transmit the RS using the second RS configuration, the more details of which have been described in the above descriptions with respect to at least the request 264, and repetitive descriptions thereof are omitted here; and an operation of transmitting, to the first device, the RS using the second RS configuration, the more details of which have been described in the above descriptions with respect to at least the RS 232 and the second RS configuration 258, and repetitive descriptions thereof are omitted here.

In an embodiment, the example method 400 may further include an operation of receiving, from the third device, a request for a second RS configuration associated with the transmission of the RS from the second device to the first device; an operation of transmitting, to the third device, the second RS configuration; and an operation of transmitting, to the first device, the RS using the second RS configuration. The more details have been described in the above descriptions with respect to at least the RS 232 and the second RS configuration 258, and repetitive descriptions thereof are omitted here.

In an embodiment, the example method 400 may further include an operation of stopping transmitting, to the first device, the RS using the second RS configuration responsive to receiving from the first device, an indication indicative of one or more events associated with the first RS configuration, or receiving from the third device, an indication to stop the transmission of the RS using the second RS configuration. The more details have been described in the above descriptions with respect to at least the operation 234, the indication 223 and the indication 266, and repetitive descriptions thereof are omitted here.

In an embodiment, the first device may comprise the SR 110, the third device may comprise the SMF 150, and the RS may be an SEN-RS.

FIG. 5 shows a flow chart illustrating an example method 500 for hierarchical measurement mechanism according to the example embodiments of the present disclosure. The example method 500 may be performed for example at a third device comprising the SMF 150.

Referring to the FIG. 5, the example method 500 may include an operation 510 of transmitting to a first device in a RAN, information indicative of one or more RS configurations and associated events, wherein the one or more RS configurations may be associated with transmission of RS from a second device in the RAN to the first device.

Details of the operation 510 have been described in the above descriptions with respect to at least the information 254, and repetitive descriptions thereof are omitted here.

In an embodiment, the example method 500 may further include an operation of receiving, from the first device, a capability of the first device, wherein the capability may comprise at least one of the following: a computing capability, an ML capability, at least one executable sensing task, device category, and power status, and the information may be determined based at least on the received capability. The more details have been described in the above descriptions with respect to at least the capability 212 and the information 254, and repetitive descriptions thereof are omitted here.

In an embodiment, the one or more RS configurations may comprise a second RS configuration associated with the transmission of the RS from a second device in the RAN to the first device. The more details have been described in the above descriptions with respect to at least the second RS configuration 258, and repetitive descriptions thereof are omitted here.

In an embodiment, the example method 500 may further include an operation of transmitting to the first device and the second device, respectively, a second RS configuration associated with the transmission of the RS from the second device to the first device, the more details of which have been described in the above descriptions with respect to at least the second RS configuration 258, and repetitive descriptions thereof are omitted here.

In an embodiment, the example method 500 may further include an operation of receiving from the first device, an indication indicative of one or more events, the more details of which have been described in the above descriptions with respect to at least the indication 218, and repetitive descriptions thereof are omitted here; and an operation of responsive to receiving the indication, transmitting to the second device, a request to transmit the RS using the second RS configuration, the more details of which have been described in the above descriptions with respect to at least the request 264, and repetitive descriptions thereof are omitted here.

In an embodiment, the example method 500 may further include an operation of receiving, from the first device, an indication indicative of one or more events; an operation of responsive to receiving the indication, transmitting to the second device, a request for a second RS configuration associated with the transmission of the RS from the second device to the first device; an operation of receiving, from the second device, the second RS configuration; and an operation of transmitting, to the first device, the second RS configuration. The more details have been described in the above descriptions with respect to at least the indication 218, the RS 232 and the second RS configuration 258, and repetitive descriptions thereof are omitted here.

In an embodiment, the example method 500 may further include an operation of receiving, from the first device, an indication indicative of one or more events, the more details of which have been described in the above descriptions with respect to at least the indication 218, and repetitive descriptions thereof are omitted here; and an operation of responsive to receiving the indication, transmitting to the first device and the second device, respectively, a second RS configuration associated with the transmission of the RS from the second device to the first device, the more details of which have been described in the above descriptions with respect to at least the second RS configuration 258, and repetitive descriptions thereof are omitted here.

In an embodiment, the example method 500 may further include an operation of receiving, from the first device, a result of measurement performed on the RS using the second RS configuration, the more details of which have been described in the above descriptions with respect to at least the measurement result 222, and repetitive descriptions thereof are omitted here; an operation of transmitting, to the first device, an indication to stop the measurement on the reference signal using the second reference signal configuration upon detecting one or more events associated with a first RS configuration based at least on the result of the measurement, the more details of which have been described in the above descriptions with respect to at least the indication 268, and repetitive descriptions thereof are omitted here; and an operation of transmitting to the second device, an indication to stop the transmission of the RS using the second RS configuration, the more details of which have been described in the above descriptions with respect to at least the indication 266, and repetitive descriptions thereof are omitted here.

In an embodiment, the first device may comprise the SR 110, the second device may comprise the ST 130, and the RS may be an SEN-RS.

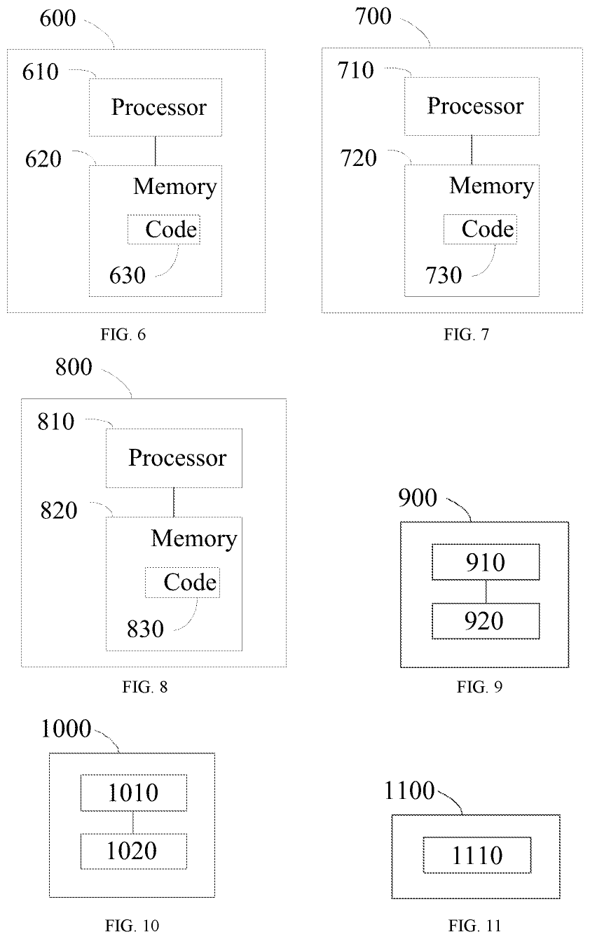

FIG. 6 shows a block diagram illustrating an example device 600 for hierarchical measurement mechanism according to the example embodiments of the present disclosure. The device, for example, may be at least part of a first device comprising the SR 110 in the above examples.

As shown in the FIG. 6, the example device 600 may include at least one processor 610 and at least one memory 620 that may include computer program code 630. The at least one memory 620 and the computer program code 630 may be configured to, with the at least one processor 610, cause the device 600 at least to perform the example method 300 described above.

In various example embodiments, the at least one processor 610 in the example device 600 may include, but not limited to, at least one hardware processor, including at least one microprocessor such as a central processing unit (CPU), a portion of at least one hardware processor, and any other suitable dedicated processor such as those developed based on for example Field Programmable Gate Array (FPGA) and Application Specific Integrated Circuit (ASIC). Further, the at least one processor 610 may also include at least one other circuitry or element not shown in the FIG. 6.

In various example embodiments, the at least one memory 620 in the example device 600 may include at least one storage medium in various forms, such as a volatile memory and/or a non-volatile memory. The volatile memory may include, but not limited to, for example, a random-access memory (RAM), a cache, and so on. The non-volatile memory may include, but not limited to, for example, a read only memory (ROM), a hard disk, a flash memory, and so on. Further, the at least memory 620 may include, but are not limited to, an electric, a magnetic, an optical, an electromagnetic, an infrared, or a semiconductor system, apparatus, or device or any combination of the above.

Further, in various example embodiments, the example device 600 may also include at least one other circuitry, element, and interface, for example at least one I/O interface, at least one antenna element, and the like.

In various example embodiments, the circuitries, parts, elements, and interfaces in the example device 600, including the at least one processor 610 and the at least one memory 420, may be coupled together via any suitable connections including, but not limited to, buses, crossbars, wiring and/or wireless lines, in any suitable ways, for example electrically, magnetically, optically, electromagnetically, and the like.

It is appreciated that the structure of the device on the side of the first device is not limited to the above example device 600.

FIG. 7 shows a block diagram illustrating an example device 700 for hierarchical measurement mechanism according to the example embodiments of the present disclosure. The device, for example, may be at least part of a second device comprising the ST 130 in the above examples.

As shown in the FIG. 7, the example device 700 may include at least one processor 710 and at least one memory 720 that may include computer program code 730. The at least one memory 720 and the computer program code 730 may be configured to, with the at least one processor 710, cause the device 700 at least to perform the example method 400 described above.

In various example embodiments, the at least one processor 710 in the example device 700 may include, but not limited to, at least one hardware processor, including at least one microprocessor such as a central processing unit (CPU), a portion of at least one hardware processor, and any other suitable dedicated processor such as those developed based on for example Field Programmable Gate Array (FPGA) and Application Specific Integrated Circuit (ASIC). Further, the at least one processor 710 may also include at least one other circuitry or element not shown in the FIG. 7.

In various example embodiments, the at least one memory 720 in the example device 700 may include at least one storage medium in various forms, such as a volatile memory and/or a non-volatile memory. The volatile memory may include, but not limited to, for example, a random-access memory (RAM), a cache, and so on. The non-volatile memory may include, but not limited to, for example, a read only memory (ROM), a hard disk, a flash memory, and so on. Further, the at least memory 720 may include, but are not limited to, an electric, a magnetic, an optical, an electromagnetic, an infrared, or a semiconductor system, apparatus, or device or any combination of the above.

Further, in various example embodiments, the example device 700 may also include at least one other circuitry, element, and interface, for example at least one I/O interface, at least one antenna element, and the like.

In various example embodiments, the circuitries, parts, elements, and interfaces in the example device 700, including the at least one processor 710 and the at least one memory 720, may be coupled together via any suitable connections including, but not limited to, buses, crossbars, wiring and/or wireless lines, in any suitable ways, for example electrically, magnetically, optically, electromagnetically, and the like.

It is appreciated that the structure of the device on the side of the second device is not limited to the above example device 700.

FIG. 8 shows a block diagram illustrating an example device 800 for hierarchical measurement mechanism according to the example embodiments of the present disclosure. The device, for example, may be at least part of a third device comprising the SMF 150 in the above examples.

As shown in the FIG. 8, the example device 800 may include at least one processor 810 and at least one memory 820 that may include computer program code 830. The at least one memory 820 and the computer program code 830 may be configured to, with the at least one processor 810, cause the device 800 at least to perform the example method 500 described above.

In various example embodiments, the at least one processor 810 in the example device 800 may include, but not limited to, at least one hardware processor, including at least one microprocessor such as a central processing unit (CPU), a portion of at least one hardware processor, and any other suitable dedicated processor such as those developed based on for example Field Programmable Gate Array (FPGA) and Application Specific Integrated Circuit (ASIC). Further, the at least one processor 810 may also include at least one other circuitry or element not shown in the FIG. 8.

In various example embodiments, the at least one memory 820 in the example device 800 may include at least one storage medium in various forms, such as a volatile memory and/or a non-volatile memory. The volatile memory may include, but not limited to, for example, a random-access memory (RAM), a cache, and so on. The non-volatile memory may include, but not limited to, for example, a read only memory (ROM), a hard disk, a flash memory, and so on. Further, the at least memory 820 may include, but are not limited to, an electric, a magnetic, an optical, an electromagnetic, an infrared, or a semiconductor system, apparatus, or device or any combination of the above.

Further, in various example embodiments, the example device 800 may also include at least one other circuitry, element, and interface, for example at least one I/O interface, at least one antenna element, and the like.

In various example embodiments, the circuitries, parts, elements, and interfaces in the example device 800, including the at least one processor 810 and the at least one memory 820, may be coupled together via any suitable connections including, but not limited to, buses, crossbars, wiring and/or wireless lines, in any suitable ways, for example electrically, magnetically, optically, electromagnetically, and the like.

It is appreciated that the structure of the device on the side of the third device is not limited to the above example device 800.

FIG. 9 shows a block diagram illustrating an example apparatus 900 for hierarchical measurement mechanism according to the example embodiments of the present disclosure. The apparatus, for example, may be at least part of a first device comprising the SR 110 in the above examples.

As shown in FIG. 9, the example apparatus 900 may include means 910 for performing the operation 310 of the example method 300, and means 920 for performing the operation 320 of the example method 300. In one or more another example embodiments, at least one I/O interface, at least one antenna element, and the like may also be included in the example apparatus 900.

In some example embodiments, examples of means in the example apparatus 900 may include circuitries. For example, an example of means 910 may include a circuitry configured to perform the operation 310 of the example method 300, and an example of means 920 may include a circuitry configured to perform the operation 320 of the example method 300. In some example embodiments, examples of means may also include software modules and any other suitable function entities.

FIG. 10 shows a block diagram illustrating an example apparatus 1000 for hierarchical measurement mechanism according to the example embodiments of the present disclosure. The apparatus, for example, may be at least part of a second device comprising the ST 130 in the above examples.

As shown in FIG. 10, the example apparatus 1000 may include means 1010 for performing the operation 410 of the example method 400, and means 1020 for performing the operation 420 of the example method 400. In one or more another example embodiments, at least one I/O interface, at least one antenna element, and the like may also be included in the example apparatus 1000.

In some example embodiments, examples of means in the example apparatus 1000 may include circuitries. For example, an example of means 1010 may include a circuitry configured to perform the operation 410 of the example method 400, and an example of means 1020 may include a circuitry configured to perform the operation 420 of the example method 400. In some example embodiments, examples of means may also include software modules and any other suitable function entities.

FIG. 11 shows a block diagram illustrating an example apparatus 1100 for hierarchical measurement mechanism according to the example embodiments of the present disclosure. The apparatus, for example, may be at least part of a third device comprising the SMF 150 in the above examples.

As shown in FIG. 11, the example apparatus 1100 may include means 1110 for performing the operation 510 of the example method 500. In one or more another example embodiments, at least one I/O interface, at least one antenna element, and the like may also be included in the example apparatus 1100.

In some example embodiments, examples of means in the example apparatus 1100 may include circuitries. For example, an example of means 1110 may include a circuitry configured to perform the operation 510 of the example method 5000. In some example embodiments, examples of means may also include software modules and any other suitable function entities.

The term “circuitry” throughout this disclosure may refer to one or more or all of the following: (a) hardware-only circuit implementations (such as implementations in only analog and/or digital circuitry); (b) combinations of hardware circuits and software, such as (as applicable) (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions); and (c) hardware circuit(s) and or processor(s), such as a microprocessor(s) or a portion of a microprocessor(s), that requires software (e.g., firmware) for operation, but the software may not be present when it is not needed for operation. This definition of circuitry applies to one or all uses of this term in this disclosure, including in any claims. As a further example, as used in this disclosure, the term circuitry also covers an implementation of merely a hardware circuit or processor (or multiple processors) or portion of a hardware circuit or processor and its (or their) accompanying software and/or firmware. The term circuitry also covers, for example and if applicable to the claim element, a baseband integrated circuit or processor integrated circuit for a mobile device or a similar integrated circuit in server, a cellular network device, or other computing or network device.

Another example embodiment may relate to computer program codes or instructions which may cause an apparatus to perform at least respective methods described above. Another example embodiment may be related to a computer readable medium having such computer program codes or instructions stored thereon. In some embodiments, such a computer readable medium may include at least one storage medium in various forms such as a volatile memory and/or a non-volatile memory. The volatile memory may include, but not limited to, for example, a RAM, a cache, and so on. The non-volatile memory may include, but not limited to, a ROM, a hard disk, a flash memory, and so on. The non-volatile memory may also include, but are not limited to, an electric, a magnetic, an optical, an electromagnetic, an infrared, or a semiconductor system, apparatus, or device or any combination of the above.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Likewise, the word “connected”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the description using the singular or plural number may also include the plural or singular number respectively. The word “or” in reference to a list of two or more items, that word covers all of the following interpretations of the word: any of the items in the list, all of the items in the list, and any combination of the items in the list.

Moreover, conditional language used herein, such as, among others, “can,” “could,” “might,” “may,” “e.g.,” “for example,” “such as” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

As used herein, the term “determine/determining” (and grammatical variants thereof) can include, not least: calculating, computing, processing, deriving, measuring, investigating, looking up (for example, looking up in a table, a database or another data structure), ascertaining and the like. Also, “determining” can include receiving (for example, receiving information), accessing (for example, accessing data in a memory), obtaining and the like. Also, “determine/determining” can include resolving, selecting, choosing, establishing, and the like.

While some embodiments have been described, these embodiments have been presented by way of example, and are not intended to limit the scope of the disclosure. Indeed, the apparatus, methods, and systems described herein may be embodied in a variety of other forms; furthermore, various omissions, substitutions and changes in the form of the methods and systems described herein may be made without departing from the spirit of the disclosure. For example, while blocks are presented in a given arrangement, alternative embodiments may perform similar functionalities with different components and/or circuit topologies, and some blocks may be deleted, moved, added, subdivided, combined, and/or modified. At least one of these blocks may be implemented in a variety of different ways. The order of these blocks may also be changed. Any suitable combination of the elements and actions of the some embodiments described above can be combined to provide further embodiments. The accompanying claims and their equivalents are intended to cover such forms or modifications as would fall within the scope and spirit of the disclosure.

Abbreviations used in the description and/or in the figures are defined as follows:
AI artificial intelligence
AMF access and mobility management function
AoA angle of arrival
AP access point
BS base station
CSI channel state information
CSI-RS channel state information reference signal
DMRS demodulation reference signal
JCAS joint communication and sensing
LMF location management function
LOS line of sight
ML machine learning
NWDAF network data analysis function
PBCH physical broadcast channel
RAN radio access network
RF radio frequency
RS reference signal
RSSI received signal strength indicator
SEN-RS sensing reference signal
SMF sensing management function
SR sensing receiver
SRS sounding reference signal
SS synchronization signal
ST sensing transmitter
STA station
UE user equipment
WLAN wireless local area network

1.-62. (canceled)

63. A first device in a radio access network, comprising:
at least one processor; and
at least one memory comprising computer program code, the at least one memory and the computer program code being configured to, with the at least one processor, cause the first device to perform:
receiving from a third device, information indicative of one or more reference signal configurations and associated events, wherein the one or more reference signal configurations are associated with transmission of a reference signal from the second device in the radio access network to the first device; and
detecting one or more events based at least on the one or more reference signal configurations.

64. The first device of claim 63, wherein the at least one memory and the computer program code are further configured to, with the at least one processor, cause the first device to further perform:
transmitting to the third device, a capability of the first device, the capability comprising at least one of the following: a computing capability, a machine learning capability, at least one executable sensing task, device category, and power status.

65. The first device of claim 63, wherein the one or more reference signal configurations comprise a first reference signal configuration, and the at least one memory and the computer program code are further configured to, with the at least one processor, cause the first device to further perform:
performing measurement on the reference signal received from the second device using the first reference signal configuration,
the one or more events being detected based on the measurement.

66. The first device of claim 65, wherein the at least one memory and the computer program code are further configured to, with the at least one processor, cause the first device to further perform:
receiving from the third device, a second reference signal configuration associated with the transmission of the reference signal from the second device to the first device.

67. The first device of claim 66, wherein the at least one memory and the computer program code are further configured to, with the at least one processor, cause the first device to further perform:
transmitting to the second device or the third device, an indication indicative of the one or more events upon detecting the one or more events; and
performing the measurement on the reference signal received from the second device using the second reference signal configuration.

68. The first device of claim 65, wherein the at least one memory and the computer program code are further configured to, with the at least one processor, cause the first device to further perform:
transmitting to the third device, an indication indicative of the one or more events upon detecting the one or more events;
receiving from the third device, a second reference signal configuration associated with the transmission of the reference signal from the second device to the first device; and
performing the measurement on the reference signal received from the second device using the second reference signal configuration.

69. The first device of claim 66, wherein the at least one memory and the computer program code are further configured to, with the at least one processor, cause the first device to further perform:
stopping the measurement on the reference signal using the second reference signal configuration upon detecting one or more events associated with the first reference signal configuration, or receiving from the third device, an indication to stop the measurement on the reference signal using the second reference signal configuration,
the one or more events associated with the first reference signal configuration being detected based on at least one of the first reference signal configuration and the second reference signal configuration.

70. The first device of claim 66, wherein the at least one memory and the computer program code are further configured to, with the at least one processor, cause the first device to further perform:
stopping the measurement on the reference signal using the first reference signal configuration upon detecting the one or more events.

71. A second device in a radio access network, comprising:
at least one processor; and
at least one memory comprising computer program code, the at least one memory and the computer program code being configured to, with the at least one processor, cause the second device to perform:
obtaining information indicative of one or more reference signal configurations and associated events, wherein the one or more reference signal configurations are associated with transmission of reference signal from the second device to a first device in the radio access network and the one or more reference signal configurations comprise at least a first reference signal configuration; and
transmitting to the first device, the reference signal using the first reference signal configuration.

72. The second device of claim 71, wherein the at least one memory and the computer program code are further configured to, with the at least one processor, cause the second device to further perform:
receiving from a third device, a second reference signal configuration associated with the transmission of the reference signal from the second device to the first device.

73. The second device of claim 72, wherein the at least one memory and the computer program code are further configured to, with the at least one processor, cause the second device to further perform:
receiving from the first device, an indication indicative of one or more events; and
responsive to receiving the indication, transmitting to the first device, the reference signal using the second reference signal configuration.

74. The second device of claim 72, wherein the at least one memory and the computer program code are further configured to, with the at least one processor, cause the second device to further perform:
receiving from the third device, a request to transmit the reference signal using the second reference signal configuration; and
transmitting to the first device, the reference signal using the second reference signal configuration.

75. The second device of claim 71, wherein the at least one memory and the computer program code are further configured to, with the at least one processor, cause the second device to further perform:
receiving from the third device, a request for a second reference signal configuration associated with the transmission of the reference signal from the second device to the first device;
transmitting to the third device, the second reference signal configuration; and
transmitting to the first device, the reference signal using the second reference signal configuration.

76. The second device of 73, wherein the at least one memory and the computer program code are further configured to, with the at least one processor, cause the second device to further perform:
stopping transmitting to the first device, the reference signal using the second reference signal configuration responsive to receiving from the first device, an indication indicative of one or more events associated with the first reference signal configuration, or receiving from the third device, an indication to stop the transmission of the reference signal using the second reference signal configuration.

77. A third device, comprising:
at least one processor; and
at least one memory comprising computer program code, the at least one memory and the computer program code being configured to, with the at least one processor, cause the third device to perform:
transmitting to a first device in a radio access network, information indicative of one or more reference signal configurations and associated events, wherein the one or more reference signal configurations are associated with transmission of reference signal from a second device in the radio access network to the first device.

78. The third device of claim 77, wherein the at least one memory and the computer program code are further configured to, with the at least one processor, cause the third device to further perform:
receiving from the first device, a capability of the first device, the capability comprising at least one of the following: a computing capability, a machine learning capability, at least one executable sensing task, device category, and power status,
the information being determined based at least on the received capability.

79. The third device of claim 77, wherein the at least one memory and the computer program code are further configured to, with the at least one processor, cause the third device to further perform:
transmitting to the first device and the second device, respectively, a second reference signal configuration associated with the transmission of the reference signal from the second device to the first device.

80. The third device of claim 77, wherein the at least one memory and the computer program code are further configured to, with the at least one processor, cause the third device to further perform:
receiving from the first device, an indication indicative of one or more events;
responsive to receiving the indication, transmitting to the second device, a request for a second reference signal configuration associated with the transmission of the reference signal from the second device to the first device;
receiving from the second device, the second reference signal configuration; and
transmitting to the first device, the second reference signal configuration.

81. The third device of claim 77, wherein the at least one memory and the computer program code are further configured to, with the at least one processor, cause the third device to further perform:
receiving from the first device, an indication indicative of one or more events; and
responsive to receiving the indication, transmitting to the first device and the second device, respectively, a second reference signal configuration associated with the transmission of the reference signal from the second device to the first device.

82. The third device of claim 77, wherein the at least one memory and the computer program code are further configured to, with the at least one processor, cause the third device to further perform:
receiving from the first device, a result of measurement performed on the reference signal using the second reference signal configuration;
transmitting to the first device, an indication to stop the measurement on the reference signal using the second reference signal configuration upon detecting one or more events associated with a first reference signal configuration based at least on the result of the measurement; and
transmitting to the second device, an indication to stop the transmission of the reference signal using the second reference signal configuration.
